(19) United States
(12) Patent Application Publication
(10) Pub. No.: US 2016/0003152 A1
(43) Pub. Date: Jan. 7, 2016

(54) GAS TURBINE ENGINE MULTI-VANED STATOR COOLING CONFIGURATION

(71) Applicant: UNITED TECHNOLOGIES CORPORATION, Hartford, CT (US)

(72) Inventors: Sarah Riley, Glastonbury, CT (US); Mark A. Boeke, Plainville, CT (US); Shawn J. Gregg, Wethersfield, CT (US)

(21) Appl. No.: 14/769,224

(22) PCT Filed: Mar. 12, 2014
(86) PCT No.: PCT/US2014/024240

§ 371 Date: Aug. 20, 2015

Related U.S. Application Data
(60) Provisional application No. 61/782,685, filed on Mar. 14, 2013.

(51) Int. Cl. F02C 7/18; F01D 9/04; F01D 25/12; F02C 3/04

(52) U.S. Cl. CPC F02C 7/18; F02C 3/04; F01D 9/041; F01D 25/12; F05D 2220/32; F05D 2240/129; F05D 2260/202; F05D 2240/80

(57) ABSTRACT

A stator for a gas turbine engine has a platform supporting multiple vanes that includes first and second vanes respectively. First and second regions are arranged at the same location on the first and second vanes. The first and second regions respectively include first and second cooling hole configurations that are different than one another.

### BACKGROUND

This disclosure relates to a gas turbine engine, and more particularly, to turbine vane platform cooling arrangements that may be incorporated into a gas turbine engine.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades.

High pressure turbine vanes are subjected to high operating temperatures and frequently require film cooling on flow path surfaces. Film cooling is facilitated by machining cooling holes through an exterior surface to an internal cooling passage.

Multi-vaned stators include multiple airfoils supported by a common platform. In some applications, a thermal barrier coating, such as ceramic, is applied to the exterior surface to provide thermal protection to the stator. At least some of the surfaces of the airfoils are obstructed by the adjacent airfoils. As a result, each airfoil may exhibit a different cooling characteristic than the adjacent airfoil.

### SUMMARY

In one exemplary embodiment, a stator for a gas turbine engine has a platform supporting multiple vanes that includes first and second vanes respectively. First and second regions are arranged at the same location on the first and second vanes. The first and second regions respectively include first and second cooling hole configurations that are different than one another.

In a further embodiment of the above, the first and second cooling hole configurations correspond to cooling hole size.

In a further embodiment of any of the above, the first and second cooling hole configurations corresponding to cooling hole shape.

In a further embodiment of any of the above, the first cooling hole configuration include an oblong exit, and the second cooling hole configuration includes a conical exit.

In a further embodiment of any of the above, the first and second cooling hole configurations corresponding to cooling hole density.

In a further embodiment of any of the above, the first and second regions are the same size. The first and second cooling configurations each include a different number of cooling holes.

In a further embodiment of any of the above, the first and second regions are provided on airfoils.

In a further embodiment of any of the above, the first and second regions are provided on pressure sides.

In a further embodiment of any of the above, the first and second regions are provided on suction sides.

In a further embodiment of any of the above, the first cooling hole configuration includes a cooling hole that has a cooling hole axis that provides a line of sight that is obstructed by the second vane.

In a further embodiment of any of the above, the platform corresponds to an outer platform. An inner platform supports the multiple vanes.

In a further embodiment of any of the above, the number of multiple vanes is two.

In one exemplary embodiment, a gas turbine engine includes a combustor that is in fluid communication with the compressor section. A turbine section in fluid communication with the combustor. The turbine section includes a platform supporting multiple vanes including first and second vanes respectively including first and second regions. The first and second regions are arranged at the same location on the first and second vanes. The first and second regions respectively include first and second cooling hole configurations that are different than one another.

In a further embodiment of any of the above, the first and second cooling hole configurations corresponding to cooling hole size.

In a further embodiment of any of the above, the first and second cooling hole configurations corresponding to cooling hole shape.

In a further embodiment of any of the above, the first and second cooling hole configurations corresponding to cooling hole density.

### BRIEF DESCRIPTION OF THE DRAWINGS

The disclosure can be further understood by reference to the following detailed description when considered in connection with the accompanying drawings wherein:

FIG. 1 schematically illustrates a gas turbine engine embodiment.

FIG. 2 is a cross-sectional view through a turbine section.

FIG. 3 is a perspective view of a multi-vaned stator for the turbine section shown in FIG. 2.

FIG. 4A is a perspective view of the turbine vane of FIG. 3 illustrating example cooling hole configurations.

FIG. 4B is a schematic partial cross-sectional view of the turbine vane of FIG. 4A.

FIGS. 5A and 5B illustrate example cooling hole regions of a multi-vaned stator.

FIGS. 6A and 6B illustrate other example cooling hole regions of a multi-vaned stator.

### DETAILED DESCRIPTION

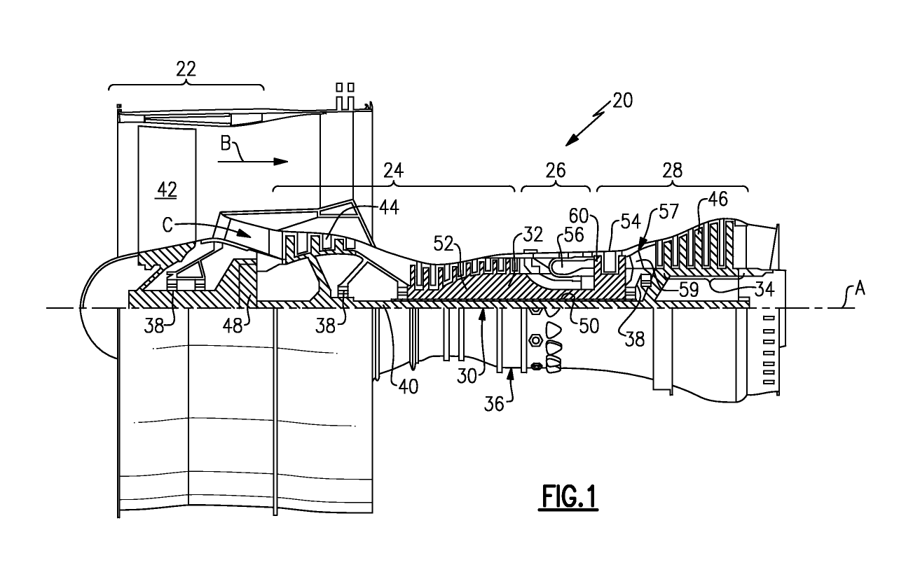

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or second) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or first) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 57 of the engine static structure 36 is arranged generally between the high pressure turbine 54 and the low pressure turbine 46. The mid-turbine frame 57 further supports bearing systems 38 in the turbine section 28 as well as setting airflow entering the low pressure turbine 46.

The core airflow C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 57 includes vanes 59, which are in the core airflow path and function as an inlet guide vane for the low pressure turbine 46. Utilizing the vane 59 of the mid-turbine frame 57 as the inlet guide vane for low pressure turbine 46 decreases the length of the low pressure turbine 46 without increasing the axial length of the mid-turbine frame 57. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption ('TSFC')”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/(518.7° R)]^{0.5}. The “Low corrected fan tip speed”, as disclosed herein according to one non-limiting embodiment, is less than about 1150 ft/second.

Referring to FIG. 2, a cross-sectional view through a high pressure turbine section 54 is illustrated. The disclosed stator cooling configuration also can be used in other areas of the turbine section 28 or in the compressor section 24. In the example high pressure turbine section 54, first and second arrays 54a, 54c of circumferentially spaced fixed vanes 60, 62 are axially spaced apart from one another. A first stage array 54b of circumferentially spaced turbine blades 64, mounted to a rotor disk 68, is arranged axially between the first and second fixed vane arrays 54a, 54c. A second stage array 54d of circumferentially spaced turbine blades 66 is arranged aft of the second array 54c of fixed vanes 62.

The turbine blades each include a tip 80 adjacent to a blade outer air seal 70 of a case structure 72. The first and second stage arrays 54a, 54c of turbine vanes and first and second stage arrays 54b, 54d of turbine blades are arranged within a core flow path C and are operatively connected to a spool 32.

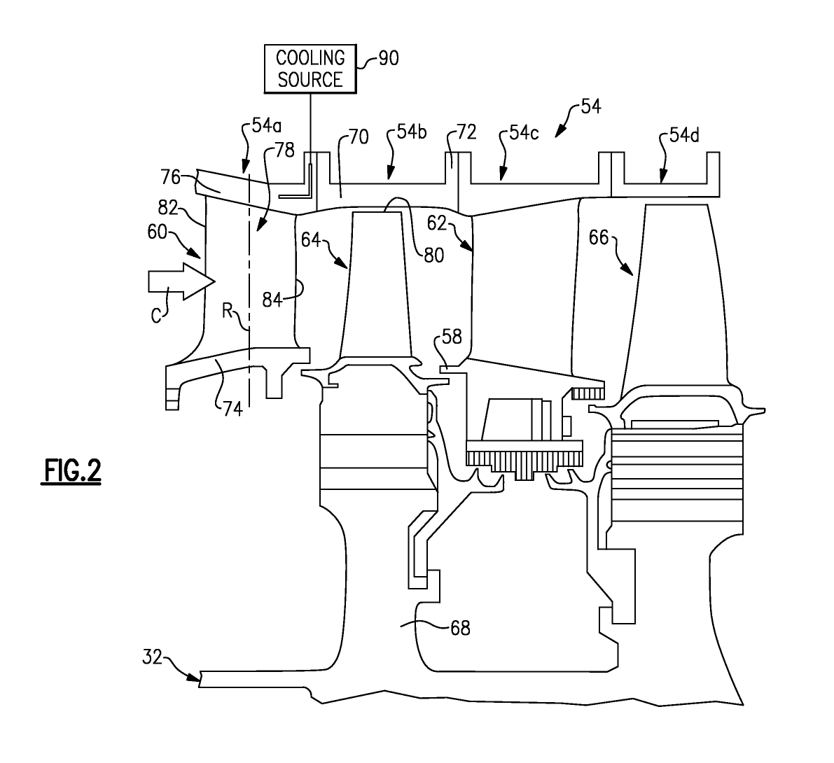

Each vane 60 includes an inner platform 74 and an outer platform 76 respectively defining inner and outer flow paths. The platforms 74, 76 are interconnected by an airfoil 78 extending in a radial direction R. It should be understood that the turbine vanes may be discrete from one another or arranged in integrated clusters. For example, a “doublet” vane cluster is illustrated in FIG. 3. With continuing reference to FIG. 2, the airfoil 78 provides leading and trailing edges 82, 84. Cooling passages within the turbine vane 60, 62 are provided cooling fluid from a cooling source 90, such as compressor bleed air that can be fed from the outer or inner diameter direction.

The turbine vanes 60, 62 are constructed from a high strength, heat resistant material such as a nickel-based or cobalt-based superalloy, or of a high temperature, stress resistant ceramic or composite material. In cooled configurations, internal fluid passages and external cooling apertures can provide for a combination of impingement and film cooling. Other internal cooling approaches may be used such as trip strips, pedestals or other convective cooling techniques. In addition, one or more thermal barrier coatings, abrasion-resistant coatings or other protective coatings may be applied to the turbine vane 60, 62.

Referring to FIG. 3, the turbine vane 60, 62 is of a “doublet” type having two airfoils 78, 178. It should be understood that the disclosed cooling arrangement may also be used with other multi-vaned configurations. The airfoils 78, 178 extend between and are interconnected to the inner and outer platform 74, 76. Airfoil 178 extends between leading and trailing edges 182, 184. Cooling passageways 91, 191 are respectively provided in the airfoils 78, 178 and are provided by correspondingly shaped core structures. The passageways are indicated by dashed lines. Fluid from the cooling source 90 (FIG. 2) is provided to the cooling passages 91, 191.

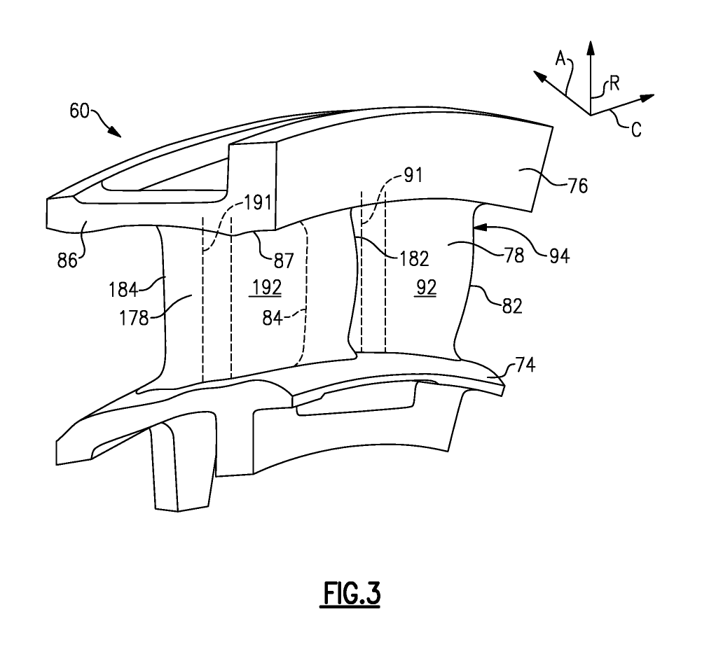

Referring to FIGS. 3, 4A and 4B, a multi-vaned stator 60 is shown. At least some of the surfaces of one or more airfoils may exhibit different cooling characteristics. The airfoil 78 has pressure and suction sides 94, 94. For example, the pressure side 92 of the airfoil 78 is obstructed by the adjacent airfoil 178. As a result, cooling enhancement coatings, such as ceramic thermal barrier coatings, may not be applied at the same thickness for both airfoils. For example, the pressure side 92 of the airfoil 78 may have a thinner coating than the pressure side 192 of the airfoil 178. To this end, it is desirable to provide cooling hole configurations on each of the vanes that are different than one another to achieve similar cooling.

An example cooling hole 104 is shown in the first vane 78. The cooling hole 104 includes an axis having a line of sight 106 that is obstructed by the adjacent second vane 178. As a result, the coating 110 may be thinner than the coating 210. Thus, it is desirable to provide enhanced cooling on the first vane 78 where the thermal barrier coating is thinner.

Cooling holes provided in obstructed line of sight areas may be machined by EDM drilling, whereas it may be desirable to machine fully accessible cooling holes using a laser.

The different cooling hole configurations are provided at the same location, for example, on either the pressure or suctions sides, on the first and second vanes 78, 178. The different cooling hole configurations may correspond to cooling different hole sizes, cooling hole shapes and/or cooling hole densities.

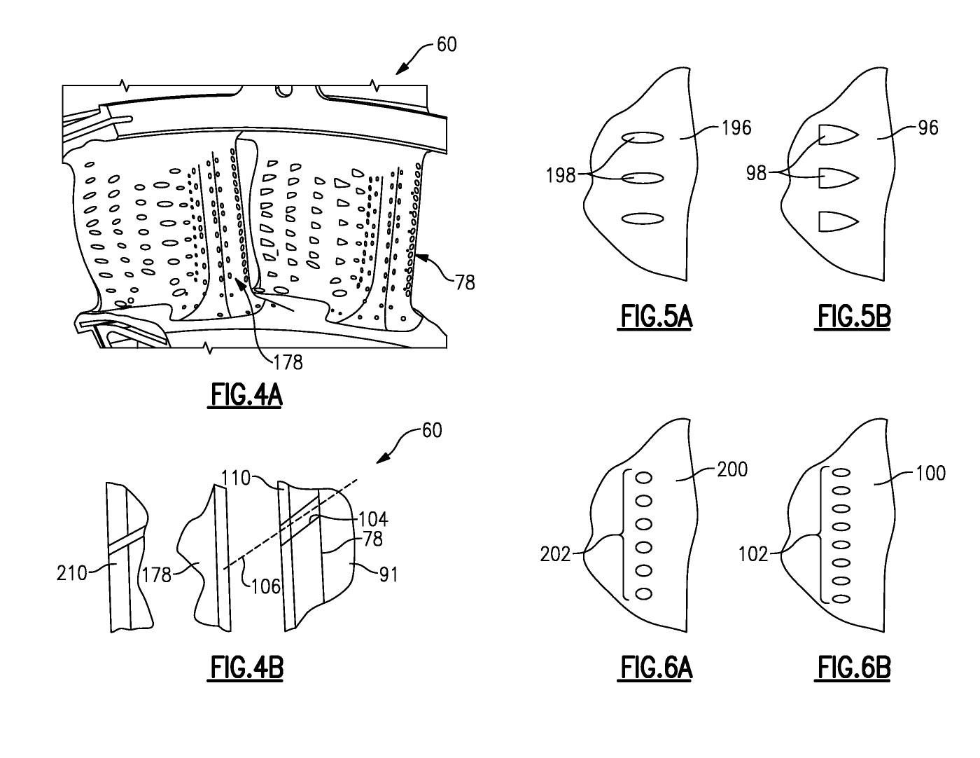

Example different cooling hole sizes and shapes are shown in FIGS. 5A and 5B. A first cooling region (or a first region) 96 includes a first cooling hole configuration, which provides holes having a conical exit 98. A second cooling region (or a second region) 196 provides a second cooling hole configuration 198 that provides holes having an oblong exit. Of course, other sizes and shapes may be used. The conical exits 98 may provide more effective film cooling, which compensates for a thinner thermal barrier coating on the first cooling region

The examples shown in FIG. 6A and 6B illustrate the different cooling hole densities. The first cooling region 100 includes a first cooling hole configuration 102 having more cooling holes than a second cooling hole configuration 202 of the second cooling region 200.

Although an example embodiment has been disclosed, a worker of ordinary skill in this art would recognize that certain modifications would come within the scope of the claims. For that reason, the following claims should be studied to determine their true scope and content.

What is claimed is:

1. A stator for a gas turbine engine comprising:
a platform supporting multiple vanes including first and second vanes respectively including first and second regions, the first and second regions arranged at a same location on the first and second vanes, the first and second regions respectively including first and second cooling hole configurations that are different than one another.

2. The stator according to claim 1, wherein the first and second cooling hole configurations corresponding to cooling hole size.

3. The stator according to claim 1, wherein the first and second cooling hole configurations corresponding to cooling hole shape.

4. The stator according to claim 3, wherein the first cooling hole configuration includes an oblong exit, and the second cooling hole configuration includes a conical exit.

5. The stator according to claim 1, wherein the first and second cooling hole configurations corresponding to cooling hole density.

6. The stator according to claim 6, wherein the first and second regions are the same size, and the first and second cooling configurations each include a different number of cooling holes.

7. The stator according to claim 1, wherein the first and second regions are provided on airfoils.

8. The stator according to claim 7, wherein the first and second regions are provided on pressure sides.

9. The stator according to claim 7, wherein the first and second regions are provided on suction sides.

10. The stator according to claim 1, wherein the first cooling hole configuration includes a cooling hole having a cooling hole axis providing a line of sight that is obstructed by the second vane.

11. The stator according to claim 1, wherein the platform corresponds to an outer platform, and including an inner platform supporting the multiple vanes.

12. The stator according to claim 11, wherein the number of multiple vanes is two.

13. A gas turbine engine comprising:
a compressor section;
a combustor in fluid communication with the compressor section;
a turbine section in fluid communication with the combustor; and
wherein the turbine section includes a platform supporting multiple vanes including first and second vanes respectively including first and second regions, the first and second regions arranged at the same location on the first and second vanes, the first and second regions respectively including first and second cooling hole configurations that are different than one another.

14. The gas turbine engine according to claim 13, wherein the first and second cooling hole configurations corresponding to cooling hole size.

15. The gas turbine engine according to claim 13, wherein the first and second cooling hole configurations corresponding to cooling hole shape.

16. The gas turbine engine according to claim 13, wherein the first and second cooling hole configurations corresponding to cooling hole density.
